(19) United States
(12) Patent Application Publication
(10) Pub. No.: US 2023/0150880 A1
(43) Pub. Date: May 18, 2023

(54) A POROUS REFRACTORY ARTICLE

(71) Applicant: Vecor IP Holdings Limited, Kowloon (HK)

(72) Inventors: Erik Severin, Kowloon (HK); John Vincent Adap Misa, Kowloon (HK); Erwin N. Fernandez, Kowloon (HK); Sandor Koszo, Kowloon (HK); Bo Wei Ma, Kowloon (HK)

(73) Assignee: Vecor IP Holdings Limited, Kowloon (HK)

(21) Appl. No.: 17/920,474

(22) PCT Filed: Apr. 23, 2021
(86) PCT No.: PCT/EP2021/060656

§ 371 Date: Oct. 21, 2022

(30) Foreign Application Priority Data
Apr. 23, 2020 (GB) 2005982.0

(51) Int. Cl. C04B 33/135; C04B 38/00

(52) U.S. Cl. CPC C04B 33/1352; C04B 38/0074; C04B 38/0054; C04B 38/0064; C04B 2235/9607; C04B 2111/28

(57) ABSTRACT

A porous refractory article including greater than 90 wt % coal combustion fly ash. The coal combustion fly ash is in the form of an interconnected particulate lattice structure, and wherein greater than 50% by volume of the coal combustion fly ash particles within the particulate lattice structure have a particle size of greater than 150 μm. The article has: (a) an apparent porosity of from 30% to 50%, (b) a porosity such that the maximum pore size is less than 500 μm; (c) a cold crushing strength of at least 4.0 MPa; and (d) a thermal conductivity of less than 1.5 W/(m·K).

### FIELD OF THE INVENTION

The present invention relates to a porous refractory article. The porous refractory article comprises greater than 90 wt % coal combustion fly ash. The porous refractory article has good strength, low thermal conductivity and good thermal resistance.

### BACKGROUND OF THE INVENTION

Coal combustion fly ash is one of the most abundant waste materials on earth. The burning of coal to generate power has resulted in the production of huge amounts of ash products. The majority of ash produced by coal combustion power stations is in the form of coal combustion fly ash, which is the fine ash that is carried out in the exhaust gases. This coal combustion fly ash is an environmental problem. Traditionally, the coal combustion fly ash was disposed of in landfill sites and thousands of square miles of land are now taken up by these landfill sites.

More recently, attempts have been made to use this coal combustion fly ash. For example, the cement industry uses some of the finer coal combustion fly ash material. However, a large amount of coal combustion fly ash, and especially the coarser coal combustion fly ash material, is still disposed of in landfill sites.

There are environmental benefits in using coal combustion fly ash, as a raw material, in as many products as possible. Using coal combustion fly ash as a raw material in other products reduces the amount going to landfill sites, and reduces the amounts of other raw materials, such as clay, that need to be used in these other products. This has environmental benefits. Increasing the range of products that can incorporate coal combustion fly ash and increasing the proportions of coal combustion fly ash that can be incorporated into such products is highly desirable.

Using coal combustion fly ash in refractory articles is not straight forward. It is difficult to incorporate very high levels of coal combustion fly ash into a refractory article and obtain a refractory article having good strength, low thermal conductivity and good thermal resistance.

A refractory article needs to be thermally resistant, i.e. it needs to be capable of withstanding high temperatures without deformation. Refractory articles are typically used to line the interiors of furnaces, ovens and boilers, amongst other applications. A good refractory article needs to be thermally resistant, and it is very desirable for the refractory article to also have a low thermal conductivity, be resistant to thermal shock, be chemically inert and physically robust. The majority of refractory articles are used in iron and steel production. Such refractory articles need to combine good thermal properties with good strength.

There are many types of refractory articles, with the majority being based on the oxides of aluminium, magnesium and silicon. Refractory articles typically have significant internal porosity to reduce their thermal conductivity. Usually, the higher the porosity, the lower the thermal conductivity.

However, increasing the porosity of the article typically reduces its strength. Highly porous refractory articles usually have poor (low) strength (e.g. low cold crushing strength and/or modulus of rupture). Typically, refractory articles are by necessity a balance of these conflicting requirements of good thermal properties and sufficient strength.

The inventors have found that coal combustion fly ash can be incorporated into refractory articles at very high levels. The inventors have found that the internal structure of the refractory article needs to be carefully controlled in order to obtain a refractory article having the desired properties of good strength, low thermal conductivity and good thermal resistance. The refractory articles of the present invention are able to withstand high temperatures without significant deformation. The refractory articles of the present invention are robust and have good thermal properties, especially thermal resistance.

M Erol et al. Characterization of sintered coal fly ashes, Fuel 87, 1334-1340, 2008 is a study of sintering behaviour of fly ash and measured density, water adsorption and porosity. There is no mention of using the sintered articles as refractory articles, and no mention of any refractory properties, such as thermal conductivity, and no mention of the strength, such as cold crushing strength, of the articles.

U.S. Pat. No. 2,652,354 relates to binding materials together to form a ceramic article. Example 17 discloses a refractory brick. However, this example differs from the present invention in that size classified fly ash is then combined with a significant amount of untreated (and not size classified) fly ash and an amount of finely ground coal. There is no mention of the thermal conductivity, no mention of the maximum pore size, and no mention of the cold crush strength of the brick.

### SUMMARY OF THE INVENTION

The present invention provides a porous refractory article, wherein the article comprises greater than 90 wt % coal combustion fly ash, wherein the coal combustion fly ash is in the form of an interconnected particulate lattice structure, and wherein greater than 50% by volume of the coal combustion fly ash particles within the particulate lattice structure have a particle size of greater than 150 μm, wherein the article has: (a) an apparent porosity of from 30% to 50%, (b) a porosity such that the maximum pore size is less than 500 μm; (c) a cold crushing strength of at least 4.0 MPa; and (d) a thermal conductivity of less than 1.5 W/(m·K).

### BRIEF DESCRIPTION OF THE DRAWINGS

FIG. 1: FIG. 1 is a schematic illustration of the porous refractory article.

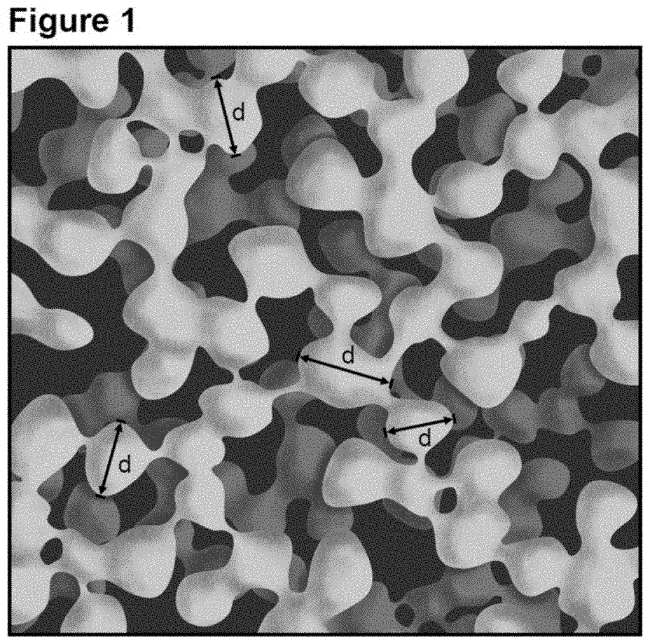

### DETAILED DESCRIPTION OF THE INVENTION

Porous refractory article. The porous refractory article comprises greater than 90 wt % coal combustion fly ash. The coal combustion fly ash is in the form of an interconnected particulate lattice structure. Greater than 50% by volume of the coal combustion fly ash particles within the particulate lattice structure have a particle size of greater than 150 μm, or greater than 160 μm, or greater than 170 μm.

Preferably, greater than 50% by volume of the coal combustion fly ash particles within the particulate lattice structure have a particle size of from greater than 150 μm to 1000 μm, or from greater than 160 μm to 800 μm, or from greater than 170 μm to 500 μm.

It may be preferred for greater than 66% of the coal combustion fly ash particles within the particulate lattice structure have a particle size of greater than 150 μm, or greater than 160 μm, or greater than 170 μm.

It may be preferred for greater than 50% of the coal combustion fly ash particles within the particulate lattice structure have a particle size of greater than 200 μm.

It may be preferred for greater than 66% of the coal combustion fly ash particles within the particulate lattice structure have a particle size of greater than 200 μm.

Typically, the predominant internal structure of the refractory article is made up of larger coal combustion fly ash particles sintered together by solidified material bridges at the contact points. The refractory article has
(a) an apparent porosity of from 30% to 50%,
(b) a porosity such that the maximum pore size is less than 500 μm;
(c) a cold crushing strength of at least 4.0 MPa; and
(d) a thermal conductivity of less than 1.5 W/(m·K).

The article has: (a) an apparent porosity of from 30% to 50%, or from 30% to 40%; (b) a porosity such that the maximum pore size is less than 500 μm, or less than 400 μm, or less than 200 μm; (c) a cold crushing strength of at least 4.0 MPa, or at least 5.0 MPa, or even at least 6.0 MPa; and (d) a thermal conductivity of less than 1.5 W/(m·K), or less than 1.25 W/(m·K), or even less than 1.0 W/(m·K).

The article may have a porosity such that the mean pore size is in the range of from 50 μm to 100 μm, or from 60 μm to 80 μm.

The article may have a modulus of rupture of at least 2.0 MPa.

It may be preferred for the article to have an apparent porosity of from 30% to 40%.

It may be preferred for the article to have an apparent porosity such that pore size distribution has: (a) a d₁₀ of greater than 3.0 μm, or greater than 4.0 μm; and (b) a d₅₀ of from 20 μm to 150 μm, or from 20 μm to 100 μm, or from 20 μm to 75 μm.

It may be preferred for the article to have an apparent porosity such that the mean pore size is in the range of from 20 μm to 150 μm, or from 20 μm to 100 μm, or from 20 μm to 75 μm.

The inventors have discovered that controlling the porosity in this manner results in a refractory article having good thermal properties and good strength. The strength can be measured either by the cold crush strength or the modulus of rupture.

The maximum pore size of a refractory article is important as larger pores act as stress concentrators and can lead to premature mechanical failure of the article. These large pores are very often the result of air incorporation during preparation of the powder mixes before firing or alternatively can be formed by the in-situ generation of gases during firing. The maximum pore size can be changed by the processing conditions used to prepare the refractory articles for firing. Powder mixes are often formed into slurries for shaping prior to firing. The mixing required to prepare the slurry can trap air, forming air pockets of varying size. Reducing the amount of water needing to be incorporated into a ceramic mix prior to forming, e.g. by using a powder-based process rather than a slurry-based process, followed by pressing, will reduce the trapping of air and thus reduce the size of any resulting pore. Large template particles, which are burnt away during firing, will also form large pores. Avoiding the use of large template particles will therefore also help control the formation of larger pores.

The apparent porosity of the article can be varied by changing the composition or particle size and size distribution or firing conditions of a sample (temperature and time) or by other techniques such as inclusion of a templating material. The more the particles in a mixture melt together, the less space will be left between the particles. A sample that has completely melted will have no apparent porosity. Changing a material to something having a higher melting point will increase apparent porosity (at a constant firing temperature) as the individual particles will deform less. Apparent porosity can be changed by changing the firing conditions. Increasing temperature will increase the degree of deformation of individual particles and hence reduce apparent porosity as particles further melt/sinter together. Increasing particle size can increase apparent porosity as the larger particles are less affected by heat and will not melt/sinter together as much. Conversely, using finer particles will reduce apparent porosity by allowing a tighter particle packing and the increased melt deformation of the smaller particles. Apparent porosity can be increased by adding a templating material to a ceramic mixture before firing. These are materials that are removed, e.g. by burning away during firing, leaving pores. Very high apparent porosities can be obtained using template materials, but such materials will very typically have low strengths.

It may be preferred for the article to have a cold crushing strength of greater than 5.0 MPa.

The strength of the article is related to the degree of sintering between the particles and the consequent strength of the resulting solid bridges, as well as the number of solid bridges. Higher firing temperatures and/or firing times will increase the degree of sintering and melting together of particles and consequent strength. Inclusion of materials that melt at lower temperatures (e.g. fluxes) will typically increase strength by reinforcing the solid bridges. Use of smaller particles means more contact points between particles and consequently more solid bridges.

It may be preferred for the article to have a modulus of rupture of greater than 2.0 MPa.

It may be preferred for the article to have a thermal conductivity of less than 1.0 W/(m·K).

Thermal conductivity is mostly controlled by the degree of contact between particles and the nature of the particles. The greater the contact between particles, the greater the cross-sectional area available for heat transfer and hence the greater the thermal conductivity of the article Therefore, thermal conductivity is usually inversely related to apparent porosity. However, large pores in a ceramic article can actually increase overall thermal conductivity as heat can be transferred by EM radiation across the pore gap. Therefore, controlling maximum pore size as well as apparent porosity will help control thermal conductivity. Thermal conductivity of a ceramic article can also be increased, if needed, by the addition of highly thermally conductive materials to the ceramic mix.

Preferably, the article comprises at least 95 wt %, or at least 99 wt %, or even consists essentially only of, coal combustion fly ash.

The article can be in the form of a tile. Tiles typically have longer lengths and breadths and limited thicknesses. A suitable tile can have a thickness of 3.0 cm or less, or 2.0 cm or less, and a length and/or breadth of greater than 20 cm, or greater than 30 cm.

The article can be in the form of a brick. The article can be in the form of a slab.

Coal combustion fly ash. The coal combustion fly ash used in the present invention is typically obtained by classification, preferably from passing coal combustion fly ash through one or more air classifiers to separate the material into the required coarse fraction and one or more finer fractions. The airflow through the classifier(s) and the speed(s) of the classifier(s) can be adjusted in order to separate the desired size fractions. Coal combustion fly ash can also be mechanically screened, preferably using ultrasonically vibrated screens, to extract the desired coarser material.

Method of making the refractory article. The refractory article is typically made by first mixing coarse coal combustion fly ash with water and a binder. A suitable binder is dextrin. The binder can be dissolved in the water and the solution used to help form a green article by pressing. Alternatively, the binder can be added as a powder and water mixed in to form a humidified blend. The humidified blend is then pressed to form a green article.

The green article is then fired to a maximum temperature of above 1400° C., or 1450° C. or above, or above 1500° C., usually 1550° C. or above, and typically ˜1600° C. This causes the larger coal combustion fly ash particles to sinter together to give the desired lattice structure but still have a discernible discrete particle structure. Typically, the firing temperature is controlled so that it does not cause the larger particles to completely vitrify into one large mass. The retention of this larger particle structure within the refractory article is key to giving the article its thermal resistivity and good insulation properties as larger particles are affected much less by higher temperatures more than finer particles hence the thermal resistivity of the larger coal combustion fly ash particles is significantly higher than that of finer particles. The internal structure can be controlled by controlling the particle size of the coal combustion fly ash starting material, by control of the compression pressure during pressing and by controlling the maximum temperature and temperature profile used during firing. The internal structure also results in significant internal porosity and hence good insulation properties.

Method of measuring the particle size of the coal combustion fly ash particles within the interconnected particulate lattice structure. The particle size of the coal combustion fly ash particles forming the interconnected lattice particulate structure is preferably measured by visual examination of exposed internal surfaces. Typically, this is done by examination of scanning electron microscopy or optical microscopy images. The initial coarse fly ash particles used to form the refractory article retain substantial and discernible aspects of their original size in that they have not melted together during sintering to form a single, low porosity coherent mass. By breaking a refractory article apart to expose the internal structure, the residual, discernible dimensions of the coal combustion fly ash particles forming the interconnected particulate lattice can be visualised by an operator. Several surfaces may be examined to minimise any errors arising from localised and unrepresentative defects.

The particle size distribution and the number of coal combustion fly ash particles may be obtained by measuring the maximum diameter of multiple separate and randomly selected particles within the field of view of a SEM (or other suitable microscope) image by visual observation. Typically, at least 25 observations of separate particles will need to be made to give statistically valid results.

Visual observation means can also be used to determine maximum void dimensions and the range of pore characteristics.

The particle size distribution and the number of coarse fly ash particles having a diameter >150 microns may be obtained by measuring the maximum internal dimension of every individually discernible particle within the field of view of a SEM image by visual observation. Several surfaces need to be examined to ensure there is no bias by localised phenomena.

The diameter of each individually identifiable particle is taken as the maximum internal dimension across two diametrically opposite edges of a particle. Each particle is assumed to be spherical for the purposes of calculation. Such assumptions are made in a variety of size measurement techniques such as laser diffraction. Size measurement by laser diffraction is also done on a basis of size as a % mass/volume.

The volume distribution of the particles in the internal structure is calculated from the number of particles and the cube of their diameters, since volume is proportional to the cube of the diameter of a spherical particle. Density can be taken as being constant for the various particles, so the weight distribution and the volume distribution are the same. The data should be plotted as the cumulative % proportion (of the total volume of all the measured particles) of the particles against the diameter of the particles.

Method of measuring the maximum pore size of a refractory article. The maximum pore size of the refractory article is determined by visual examination of exposed internal surfaces by examination of microscopy images including microscopy. Several surfaces may be examined to minimise any errors arising from localised and unrepresentative defects. Several polished and flat cross-sectional sections of the refractory article need to be prepared and examined under the microscope. The maximum pore dimension is taken as the largest internal diameter measured across any visible pore space.

Method of measuring apparent porosity. The apparent porosity of the samples is measured according to ASTM C20. The exterior volume of the test sample is first calculated as follows. The dried sample is weighed (weight=D) and then boiled in water for two hours and then allowed to cool, whilst still fully submerged, for at least 12 hours. The weight of the sample whilst in the water is then measured (by suspending the sample from a loop of wire attached to a balance (after taring the wire etc). This gives the suspended weight S. The sample is then removed from the water and surface dried and weighed. This is the Saturated Weight W.

The volume V of the sample is then W−S.

The apparent % porosity P is then calculated from P=((W-D)/V)*100

The pore size distribution of the sample is best measured by mercury porosimetry according to ASTM D4284-12. Part of the refractory article needs to be crushed and sieved to produce a size fraction between 600 μm and 1180 μm. The use of particles of the refractory article may introduce minor errors due to surface pores but these will be very small as a proportion of the whole. Using particles will aid in the penetration of the mercury.

Mercury will not wet the surface of the refractory article and will only enter a pore when forced to do so by pressure. There is a relationship between the pressure applied to mercury and the size of the pore it will enter into at that pressure.

The test needs to be carried out in a mercury penetrometer operated according to manufacturer's instructions. The sample to be tested is outgassed and placed in the penetrometer of the test equipment. The penetrometer and sample are placed in the pressure vessel of the porosimeter. The pressure is progressively increased forcing mercury into pores and the volume intruded at each pressure is recorded. This allows the cumulative pore size distribution and total pore volume to be calculated. Suitable equipment includes the AutoPore V Series Mercury Porosimeters from Micromeritics Instrument Corporation.

Method of measuring cold crushing strength. The cold crushing strength of the samples is measured according to ASTM C133. A cylinder of the test material of dimension 5.08 cm (2 inches) by 5.08 cm (2) inches is compressed at a strain rate of 1.3 mm/min and the force needed to cause failure of the sample is measured.

The Modulus of Rupture Test. The MOR of a sample can be measured by testing a sample according to ASTM C1505-15. The tile being tested, such as those produced below, is placed resting on two parallel, cylindrical support rods such that the edges of the tile are parallel to the axis of the rods. The span between the rods is a defined distance L and the edges of the tile need to overhang the support rods. The test tiles have a width b (mm) and a thickness h (mm). A third rod is placed across the middle of the tile and parallel to the others. An increasing load is applied to the middle rod until the test tile ruptures or breaks at the breaking load P (N). This can be used to calculate B, the breaking strength, using the equation B=(P×L)/b. The Modulus of Rupture R is then given by the equation R=3B/2h².

Method of measuring thermal conductivity. The thermal conductivity of the refractory articles can be measured according to ASTM C113/C113M 09(2019) “Standard Test Method for Thermal Conductivity of Refractories by Hot Wire (Platinum Resistance Thermometer Technique)”. A constant electrical current is applied to a pure platinum wire of known length and resistance which is closely placed between two bricks of fixed dimensions of the material being tested. The wire and bricks are placed in an oven and allowed to equilibrate to constant temperature. A known current is then passed through the platinum. The passage of the current generates heat. The rate at which the wire heats up is dependent upon how rapidly heat flows from the wire into the constant-temperature mass of the refractory brick. The rate of temperature increase of the platinum wire is accurately determined by measuring its increase in resistance in a similar way to how a platinum resistance thermometer is used. A Fourier equation is used to calculate the thermal conductivity based on the rate of temperature increase of the wire and power input.

### Examples

### Example 1—Inventive Example

A sample of fly ash was sieved to have a d₅₀ of 180 μm and d₁₀ of 100 μm.

This coarse material was then mixed using agitation with 3 wt % dextrin and 4.2 wt % water. 15 g of the mixture was then pressed in a circular mold of 25 mm diameter to form a green article using a pressure of 61 MPa. The sample was fired to an upper temperature of 1450° C. The sintered article had an apparent porosity of 37% and a cold crush strength of 40 MPa. On breaking the article in pieces and examination of the internal surface, it could be seen that the structure was made up of discrete sintered particles with >50%>150 μm in diameter. This article was able to withstand temperatures of 1400° C.-1500° C. in subsequent use without significant deformation.

### Example 2—Comparative Example

A similar article using identical conditions was made but using fly ash with a d₅₀ of 30 μm. This green article deformed excessively during initial firing and could not be used further.

1. A porous refractory article, wherein the article comprises greater than 90 wt % coal combustion fly ash, wherein the coal combustion fly ash is in the form of an interconnected particulate lattice structure, and wherein greater than 50% by volume of the coal combustion fly ash particles within the particulate lattice structure have a particle size of greater than 150 μm, wherein the article has:
(a) an apparent porosity of from 30% to 50%,
(b) a porosity such that a maximum pore size is less than 500 μm;
(c) a cold crushing strength of at least 4.0 MPa; and
(d) a thermal conductivity of less than 1.5 W/(m·K).

2. An article according to claim 1, wherein greater than 66% by volume of the coal combustion fly ash particles within the particulate lattice structure have a particle size of greater than 150 μm.

3. An article according to claim 1, wherein greater than 50% by volume of the coal combustion fly ash particles within the particulate lattice structure have a particle size of greater than 200 μm.

4. An article according to claim 1, wherein greater than 66% by volume of the coal combustion fly ash particles within the particulate lattice structure have a particle size of greater than 200 μm.

5. An article according to claim 1, wherein the article has a porosity such that a mean pore size is in a range of from 20 μm to 150 μm.

6. An article according to claim 5 wherein the mean pore size is in the range of from 50 μm to 100 μm.

7. An article according to claim 1, wherein the apparent porosity is from 30% to 40%.

8. An article according to claim 1, wherein the cold crushing strength is greater than 5.0 MPa.

9. An article according to claim 1, wherein the thermal conductivity is less than 1.0 W/(m·K).

10. An article according to claim 1, wherein the article has a porosity such that pore size distribution has:
(a) a d₁₀ of greater than 3.0 μm; and
(b) a d₅₀ of from 20 μm to 75 μm.

11. An article according to claim 1, wherein the article comprises at least 95 wt % coal combustion fly ash.

12. An article according to claim 1, wherein the article comprises at least 99 wt % coal combustion fly ash.

13. An article according to claim 1, wherein the article is in the form of a tile.

14. An article according to claim 1, wherein the article is in the form of a brick.

15. An article according to claim 1, wherein the article is in the form of a slab.
